(19) United States
(12) Patent Application Publication
(10) Pub. No.: US 2003/0081629 A1
(43) Pub. Date: May 1, 2003

(54) Automatic masking of interrupts

(76) Inventors: Martin Raymond Scott, Perrancoombe (GB); Timothy Michael Edward Frost, Plymouth (GB); James F. Kosolowski, Woodlawn (CA); Geoffrey Edward Floyd, Devon (GB)

Correspondence Address: MOSER, PATTERSON & SHERIDAN, L.L.P., Suite 1500, 3040 Post Oak Blvd., Houston, TX, 77056, US

(21) Appl. No.: 10/262,240

(22) Filed: Oct. 1, 2002

(30) Foreign Application Priority Data
Nov. 1, 2001 (GB) 0126246.8

(51) Int. Cl. H04J 3/16

(52) U.S. Cl. 370/465

(57) ABSTRACT

A system is provided for transmitting constant bit rate data across a packet network, the system comprising:

a first device, being a constant bit rate data to packet device, for converting constant bit rate data into packets for transmission across said packet network;

a second device, being a packet to constant bit rate data device, for converting said packets back into constant bit rate data after transmission across said packet network; and

a central processing unit arranged to receive interrupts generated by said second device, said interrupts indicating that there has been an error in packet data received by said second device,

wherein said second device automatically masks said interrupts until said second device has received the first packet for a given connection.

The invention relates to the automatic masking of interrupts in systems sending constant bit rate data over packet networks.

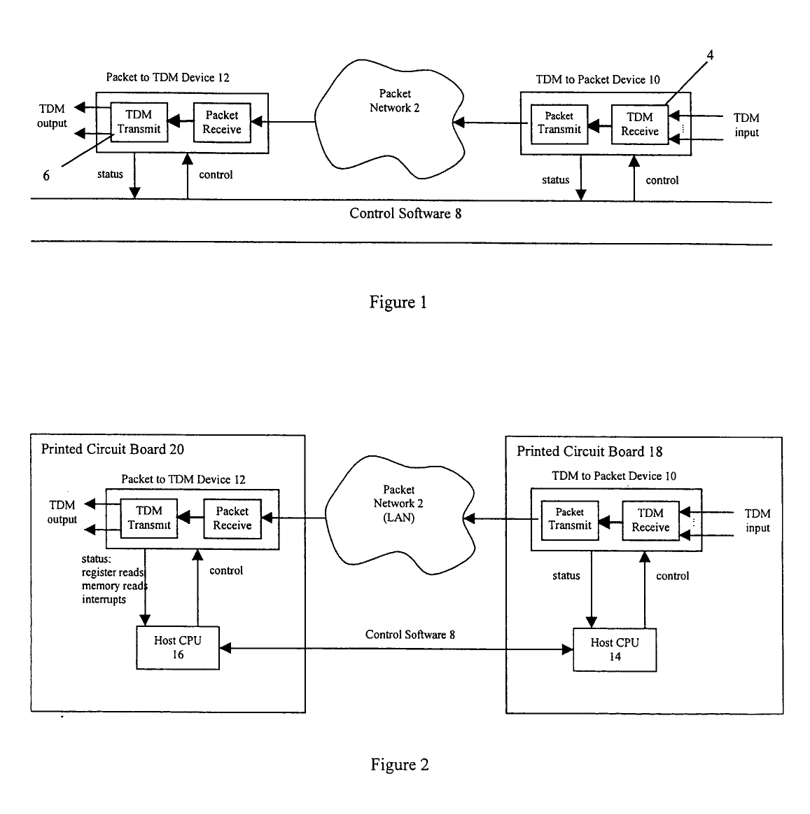

FIG. 1 shows a known system that is required to transmit constant bit rate TDM data across a packet network 2 so that it can be reconstructed as TDM data at the far end. The TDM Receiver 4 assembles incoming channels into packets. The TDM transmitter 6 performs the reverse function extracting channels from packets.

Control Software 8 is required to set up and teardown connections, and to specify the mapping of channels into packets.

The Control Software 8 is able to obtain status information from the TDM to packet, and packet to TDM, devices 10 and 12 by means of reading registers, memory locations and by receiving interrupts.

The Control Software 8 may be physically implemented in a number of ways. FIG. 2 shows an arrangement in which each device (10, 12) has a local host CPU (14, 16) that is resident on the same printed circuit board (18, 20).

Interrupts may be used to inform the Host CPU (14, 16) when error conditions occur, so that the Control Software 8 may take appropriate action. However, each interrupt received by the Host CPU (14, 16) will cause the Host CPU (14, 16) to execute an Interrupt Service Routine which will take a significant amount of the available processing power of the Host CPU (14, 16), and will divert it from its other duties.

One type of error that may occur in the Packet to TDM Device 12 is underrun. This condition occurs when the TDM Transmitter 6 has no data with which to supply a TDM channel at the time that it is required to drive the output. Because the TDM output is constant bit rate, it cannot wait and it must output a data value. In this case an underrun is said to have occurred and the actual data that is driven onto the output is known as the underrun value.

If an underrun occurs on a connection that has been set up by the Control Software 8 while data from a packet is being transmitted from the TDM output, i.e. during transmission of data from the packet, then it is a serious error because it represents a distortion from the data that was received at the TDM input. This also applies if an underrun occurs in between transmission of data from consecutive packets on a connection that has been set up by the Control Software 8.

According to the invention there is provided a system and method as set out in the accompanying claims.

The automatic masking operation proposed will automatically prevent any underrun events from generating interrupts to the Host CPU until the first packet has arrived at the Packet to TDM device, and has started transmission at the TDM outputs. After this time, any underruns will cause an interrupt unless specifically masked out by the Host CPU.

The invention allows the following advantages:

Simplify writing of the Control Software by removing the requirement for the Control Software to attempt to mask or unmask unwanted underrun interrupts.

Avoid the difficulty of synchronising this behaviour with the arrival of the first packet.

Remove processing load from the Host CPU by automatically masking out spurious interrupts synchronised to the arrival of the first packet for a new connection.

An embodiment of the invention will now be described, by way of example only, with reference to the accompanying drawings, in which:

FIG. 1 shows a known system for transmitting constant bit rate TDM data across a packet network;

FIG. 2 shows an embodiment of the system of FIG. 1 which is suitable for implementation of the invention; and

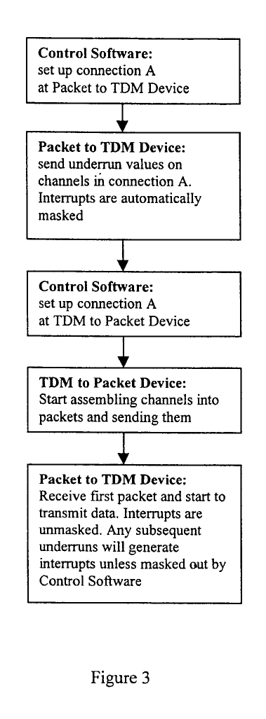

FIG. 3 is a flow diagram showing the steps in a method implementing the invention.

Referring to FIG. 2, as described above there is shown a system for transmitting constant bit rate TDM data across a packet network, in which host CPUs 14 and 16 are mounted on the same printed circuit boards (18, 20) as the TDM to packet device 10 and the packet to TDM device 12, respectively.

As described above, if an underrun occurs during the transmission of data from a packet then this is a serious error.

However, there exists a period between the time at which the Control Software 8 sets up the connection, and the time at which the first packet is received at the Packet to TDM device 12. Also, this period is indeterminate due to the nature of the packet network 2. Therefore, potentially a very large number of underruns will occur during this period that do not represent true error conditions, and that if conveyed to the Host CPU 16 as interrupts will consume significant processing power in order to discard them.

Interrupts have the facility to be masked (or disabled) by the Host CPU (14, 16). In this case, the Host CPU (14, 16) can set a bit in the device (10, 12) which prevents an underrun event from generating an interrupt. Then at a later time the interrupt can be unmasked (or enabled) by the CPU. This requires the Host CPU (14, 16) to perform write operations to the device and also presents a timing problem because the Host CPU (14, 16) does not know exactly when the TDM output starts to transmit the first packet and so is not able to synchronise the unmasking event accurately.

A better system is shown in the method described by the flow chart of FIG. 3. In this method, the packet to TDM device 12 automatically unmasks interrupts to the host CPU 16 until it has started to transmit data from the first received packet.

The following variations to embodiments of the invention are noted:

Application to other error indications apart from underrun such as framing alignment.

Other implementations of the Control Software where the interrupts take the form of status indications.

Other arrangements for the Host CPU function which may use one or more CPUs local or remote to the device.

The mechanism described may apply to packets that are mapped to any number of TDM streams & channels.

The invention is applicable to any applications sending constant bit rate data over packet streams.

1. A system for transmitting constant bit rate data across a packet network, the system comprising:
a first device, being a constant bit rate data to packet device, for converting constant bit rate data into packets for transmission across said packet network;
a second device, being a packet to constant bit rate data device, for converting said packets back into constant bit rate data after transmission across said packet network; and
a central processing unit arranged to receive interrupts generated by said second device, said interrupts indicating that there has been an error in packet data received by said second device,
wherein said second device automatically masks said interrupts until said second device has received the first packet for a given connection.

2. A system as claimed in claim 1, wherein said interrupts are automatically unmasked by said second device once said second device has started to transmit constant bit rate data corresponding to said first packet.

3. A system as claimed in claim 1 or 2, wherein control software is provided to set up and terminate connections.

4. A system as claimed in claim 3, wherein after said interrupts are unmasked, the control software may mask any further interrupts generated by said second device.

5. A system as claimed in any preceding claim, wherein said interrupts are underrun interrupts, indicating that there has been an underrun in packet data received by said second device.

6. A system as claimed in any preceding claim, wherein said second device and said central processing unit are both located on the same printed circuit board.

7. A system as claimed in any preceding claim, wherein said first and second devices are each provided with a respective central processing unit.

8. A system as claimed in any preceding claim, wherein said constant bit rate data is TDM data.

9. A method for transmitting constant bit rate data across a packet network, the method comprising:
converting constant bit rate data into packets for transmission across said packet network;
converting said packets back into constant bit rate data after transmission across said packet network;
automatically masking interrupts until the first packet for a given connection has been received after transmission across said packet network.

10. A method as claimed in claim 9, which uses a system as claimed in any of claims 1 to 8.
